(19) United States
(12) Patent Application Publication
(10) Pub. No.: US 2017/0334091 A1
(43) Pub. Date: Nov. 23, 2017

(54) SYSTEMS AND METHODS FOR DRYING SKINNED CERAMIC WARES USING RECYCLED MICROWAVE RADIATION

(71) Applicant: Corning Incorporated, Corning, NY (US)

(72) Inventors: James Anthony Feldman, Campbell, NY (US); Jacob George, Horseheads, NY (US); Amit Halder, Painted Post, NY (US); Nadezhda Pavlovna Paramonova, Saint-Petersburg (RU)

(21) Appl. No.: 15/522,627

(22) PCT Filed: Oct. 27, 2015
(86) PCT No.: PCT/US2015/057536

§ 371 Date: Apr. 27, 2017

Related U.S. Application Data
(60) Provisional application No. 62/068,845, filed on Oct. 27, 2014.

(51) Int. Cl. B28B 11/24; H05B 6/80; H05B 6/78; C04B 40/00; F26B 3/347; B28B 11/04; C04B 41/50; C04B 41/00; C04B 41/87; H05B 6/70

(52) U.S. Cl. CPC B28B 11/243; C04B 41/87; H05B 6/80; H05B 6/78; H05B 6/708; F26B 3/347; B28B 11/04; C04B 41/5025; C04B 41/0045; C04B 40/0014; B28B 11/241; H05B 2206/046

(57) ABSTRACT

Systems and methods for drying skinned ceramic wares (10) using recycled microwave radiation are disclosed. The method includes irradiating wet skinned ceramic wares (10W) in a first applicator section (124W) with microwave radiation (212), wherein said irradiating (212) gives rise to reflected microwave radiation (212R). The method also includes capturing a portion of the reflected microwave radiation (212R) and irradiating a plurality of semi-dry skinned ceramic wares (105) in a second applicator section (124S) with the reflected microwave radiation (212R). Systems for carrying out the method are also disclosed.

This application claims the benefit of U.S. Provisional Patent Application Ser. No. 62/068,845, filed on Oct. 27, 2014, the content of which is relied upon and incorporated herein by reference in its entirety.

### FIELD

The present disclosure relates to microwave drying of ceramic wares, and in particular relates to systems and methods for drying skinned ceramic wares using recycled microwave radiation.

The entire disclosure of any publication or patent document mentioned herein is incorporated by reference, including U.S. patent application Ser. No. 14/295,536, filed on Jun. 4, 2014.

### BACKGROUND

Ceramic greenwares having an array of microchannels are formed by extrusion and then processed (i.e., dried and fired) to form dry ceramic articles or “ceramic wares,” such as filters and catalytic converters having a honeycomb porous structure for use in exhaust-producing engines and related applications. Ceramic greenwares can be formed by extruding a plasticized batch comprising ceramic-forming components, or ceramic precursors, through a die, such as a die that produces a honeycomb structure, to form an extrudate of the ceramic-forming material. The extrudate that exits the extruder is cut transversely to the direction of extrusion to form a greenware piece. The piece may itself be transversely cut into shorter pieces after drying.

The ceramic ware dimensions can vary due to drying and firing shrinkage during manufacturing. Ceramic wares can also be difficult to manufacture to the stringent external dimensional requirements set by original equipment manufacturers (OEMs) and the supply chain. To help ensure compliance with dimensional requirements, ceramic wares can be machined or “contoured” to a desired dimension. A thin layer of ceramic cement is then used to form an exterior skin that provides a smooth protective outer surface for the ceramic ware.

The ceramic skin (also called “skin cement” or just “skin”) is applied wet, containing for example 10%-35% by weight of water. The skin needs to be dried to form the final ware or article. In some cases, the skin needs to be dried to greater than 98% dry (i.e., to having less than 2% of the original moisture content). The act or process of applying ceramic cement to the exterior of the ceramic ware is referred to herein as “skinning.” A ceramic ware having skin disposed thereon is referred to herein as a “skinned” ceramic ware.

Ceramic wares are currently skinned after firing, and the skin is dried using hot air. However, this drying process often leads to the formation of cracks in the skin, which need to be repaired manually. The added labor and time for inspecting skinned honeycomb bodies and fixing of skin drying cracks leads to inefficiencies in product manufacturing. To avoid skin drying cracks, a slow drying process can be employed, but this results in additional product manufacturing inefficiencies.

### SUMMARY

An aspect of the disclosure is a method of drying wet skinned ceramic wares. The method includes: a) irradiating a plurality of the wet skinned ceramic wares in a first applicator section with microwave radiation have a wavelength λ and a first amount of microwave power P1, wherein said irradiating gives rise to reflected microwave radiation from the first applicator section; and b) capturing a portion of the reflected microwave radiation and irradiating a plurality of semi-dry skinned ceramic wares in a second applicator section with the reflected microwave radiation having a second amount of microwave power P2<P1 to form dried skinned ceramic wares.

Another aspect of the disclosure is a method of performing microwave drying of multiple skinned ceramic wares formed from fired ceramic wares. The method includes: a) applying a layer of skin to each of the fired ceramic wares to form the multiple skinned ceramic wares; b) irradiating the multiple skinned ceramic wares in a first applicator section with microwave radiation; c) conveying the irradiated multiple skinned ceramic wares to a second applicator section while conveying additional multiple skinned ceramic wares into the first application section; and d) irradiating the multiple skinned ceramic wares in the second applicator section using a portion of the microwave radiation that is reflected from the first applicator section and then directed to the second applicator section.

Another aspect of the disclosure is a system for performing microwave drying of skinned ceramic wares. The system includes: first and second applicator sections; a microwave source configured to generate microwave radiation having a wavelength λ; and a microwave waveguide system comprising a first microwave waveguide operably connected to the first applicator section and to the microwave source, and a second microwave waveguide operably connected to the second applicator section and to the first microwave waveguide at a circulator arranged between the microwave source and the first applicator section to define a reflected-microwave path from the first applicator section to the second applicator section.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiments, and together with the Detailed Description serve to explain principles and operation of the various embodiments. As such, the disclosure will become more fully understood from the following Detailed Description, taken in conjunction with the accompanying Figures, in which:

FIG. 1 is an isometric side view of an example skinned ceramic ware;

FIG. 2A is a front-on, close-up view of a pre-skinned (i.e., unskinned) ceramic ware;

FIG. 2B is similar to FIG. 2A, but for the skinned ceramic ware of FIG. 1;

FIG. 3 is a schematic side view of an example microwave drying system configured to perform microwave drying using recycled microwave radiation, wherein the system includes a single applicator divided into two sections;

FIG. 4 is a top-down view of the microwave drying system of FIG. 3, but without the ceiling of the applicator to show the skinned ceramic wares within the applicator;

FIG. 5 is a top-down view of the microwave drying system of FIG. 4, showing the applicator without the ceiling to illustrate an example of how the skinned ceramic wares are arranged within and conveyed through the two applicator sections;

FIG. 6A is a schematic view of wet skinned ceramic wares residing in the wet applicator section beneath a microwave waveguide segment and schematically illustrates the irradiation of the wet skinned ceramic wares with microwave radiation;

FIG. 6B is similar to FIG. 6A and illustrates how a portion of the microwave radiation gets reflected from the wet skinned ceramic wares, as well as from other items and surfaces (not shown), within the wet applicator section, and is captured by the microwave waveguide segment;

FIG. 7 is similar to FIG. 3, and shows an example microwave drying system that utilizes spaced apart applicators to define the first and second applicator sections rather than using a single applicator divided into the two applicator sections; and

FIG. 8 is a top-down view of wet skinned ceramic wares as arranged on the conveyor, illustrating an example configuration wherein adjacent wares are spaced apart from one another by a spacing S<λ/2, where λ is the free-space wavelength of the microwave radiation.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

Cartesian coordinates are shown in some of the Figures for the sake of reference and are not intended to be limiting as to direction or orientation.

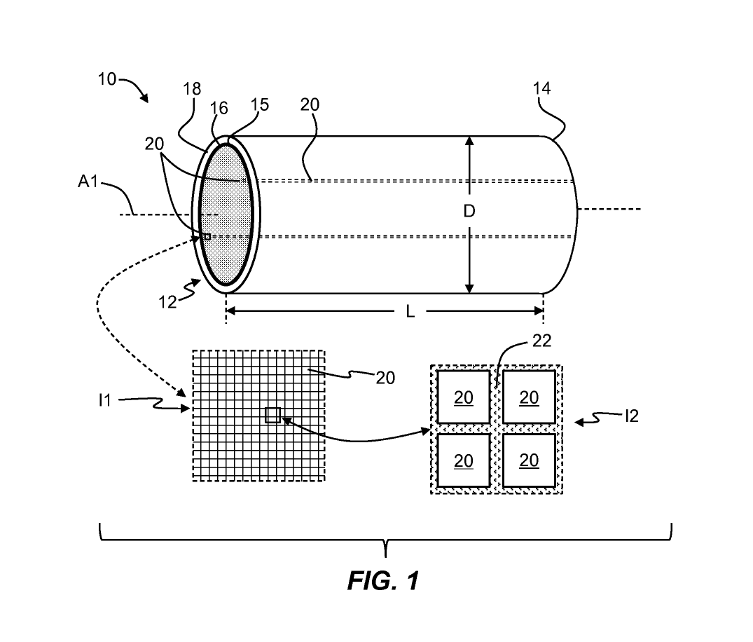

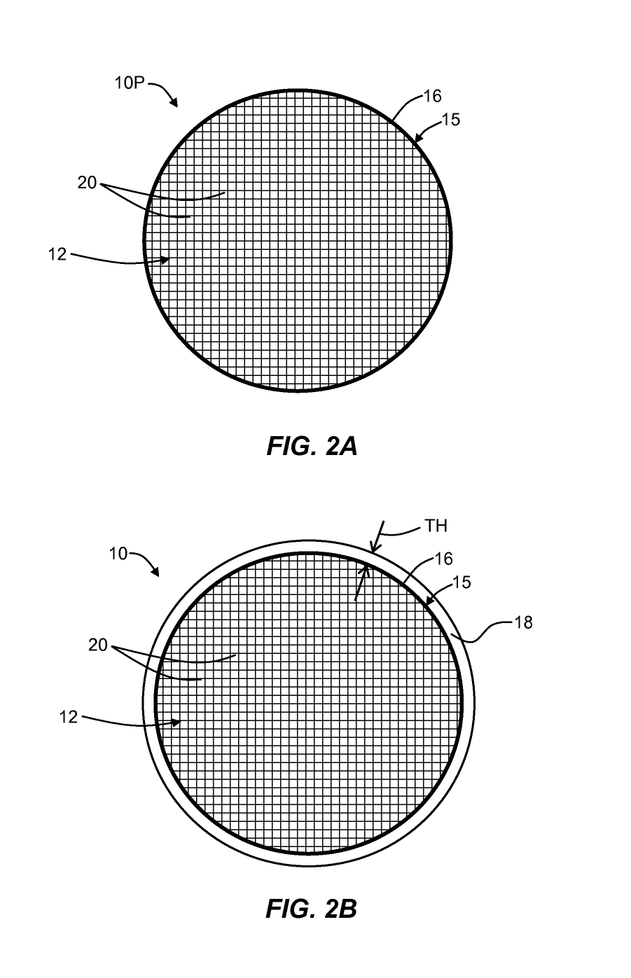

FIG. 1 is an isometric side view of an example skinned ceramic ware 10, while FIG. 2A is a front-on, close-up view of a pre-skinned (i.e., un-skinned) ceramic ware 10P of FIG. 1. FIG. 2B is similar to FIG. 2A but for the skinned ceramic ware 10 of FIG. 1. The skinned ceramic ware 10 has a central axis A1, a front end 12, a back end 14, and a cylindrical outer wall 15 that includes cylindrical surface 16 on which is formed a layer of skin (“skin”) 18. The ceramic ware 10 minus skin 18 constitutes the aforementioned pre-skinned or unskinned ceramic ware 10 of FIG. 2A. The ceramic ware 10 can have any reasonable cross-sectional shape that can be obtained using an extrusion process, such as circular, elliptical, asymmetrical, etc.

In an example, skinned ceramic ware 10 has an array of longitudinally running cells 20 that are open at front and back ends 12 and 14 of the ware (see first close-up inset 11 of FIG. 1). The cells 20 are defined by cell walls 22 (see second dose-up inset 12). In an example, cells 20 form a porous honeycomb structure.

As noted above, skin 18 is usually applied to the cylindrical surface 16 of the unskinned ceramic ware 10P after it has been dried and fired, and after the fired ceramic ware has been processed to have desired dimensions. This processing includes shaping or contouring, and can also include grinding of the front and/or back ends 12 and 14. Typically, skin 18 does not cover the front and back ends 12 and 14 of the ceramic ware.

The material making up skin 18 can be applied to cylindrical surface 16 of cylindrical wall 15 using any of the known methods, e.g., by a doctor blade operation, by an axial skinning operation, by a spray casting operation, by a tape casting operation, or the like. The material of skin 18 that contacts the underlying cylindrical surface 16 of cylindrical wall 15 bonds thereto when the skin is cured.

In exemplary embodiments, skin 18 has a thickness TH on the order of millimeters, e.g., 0.5 mm to 4 mm. In one example, the skin thickness TH can be from about 0.5 mm to about 2.1 mm. For example, the skin thickness TH can be from about 0.5 to about 1.1 mm, or about 1.0 mm to about 1.5 mm, or even from about 1.4 mm to about 2.1 mm. When skin 18 is applied over an existing skin or the skin is a multi-layer skin, the total skin thickness TH can be about twice that of a single-layer skin.

The composition of skin 18 can be any one of the compositions used in the art of ceramic ware formation. Example compositions for skin 18 are described in U.S. patent application Ser. No. 13/770,104, filed on Feb. 19, 2013. According to exemplary embodiments, the skin composition may comprise an inorganic filler material and a crystalline inorganic fibrous material. In exemplary embodiments, the inorganic filler material comprises at least 10% of the total weight of the inorganic solid components of the cement mixture and the crystalline inorganic fibrous material comprises less than 25% of the total weight of the inorganic solid components of the cement mixture. In an example, skin 18 is made of substantially the same material that constitutes pre-skinned ceramic ware 10P.

As discussed above, the process of forming skinned ceramic ware 10 includes drying the wet skin 18 after it is applied to the cylindrical surface 16 of cylindrical wall 15 of the unskinned ceramic ware 10P. In the discussion below, a skinned ceramic ware whose skin is wet (i.e., undried) has an original moisture content (e.g., 10% to 35% by weight of water) is referred to herein as a “wet skinned ceramic ware” 10W. A skinned ceramic ware whose skin is partially dried or “semi-dry” is referred herein as a “semi-dry skinned ceramic ware” 10S. For convenience and for consistency of terminology, in the discussion below, a dried skinned ceramic ware is denoted 10D. A reference to a “skinned ceramic ware” 10 can include a wet, a semi-dry or a dried skinned ceramic ware.

In an example, the skin 18 of semi-dry skinned ceramic ware 10S has a skin moisture content of between 30% and 60% of the original skin moisture content of the wet skinned ceramic ware 10W. In an example, the skin 18 of a dried skinned ceramic ware 10D has a moisture content of 10% or less of the original moisture content of the wet skinned ceramic ware 10W.

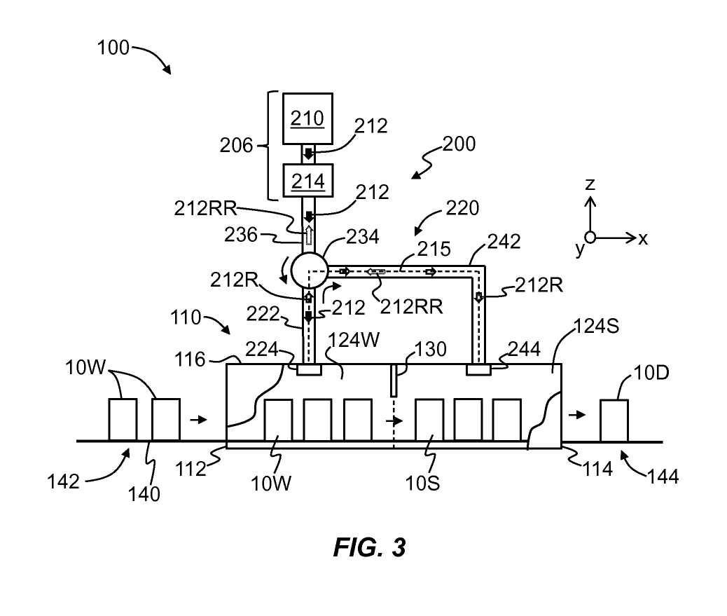

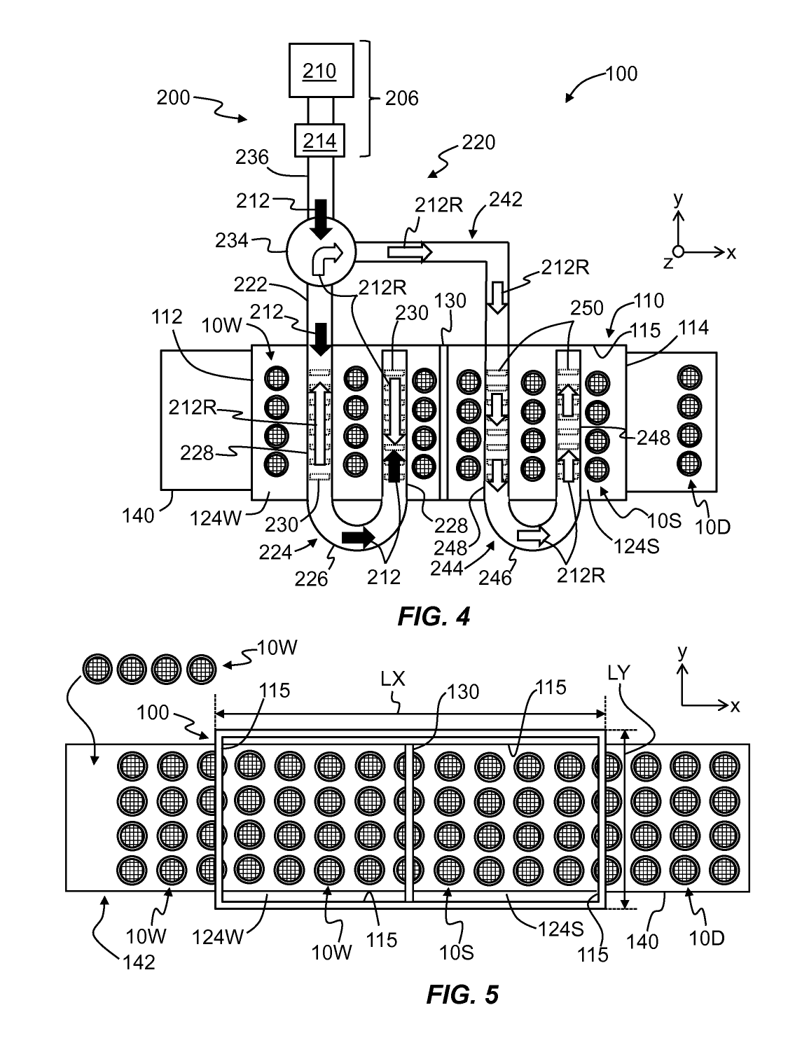

FIG. 3 is a schematic side view of an example microwave drying system (“system”) 100 for drying skinned ceramic wares 10 according to the methods disclosed herein. The system 100 includes a microwave dryer or applicator 110 that has an input end 112, an output end 114, walls 115 (see FIG. 4), a ceiling 116, and an interior divided into first and second interior sections (“sections”) 124W and 124S by a shielding member 130, where the first section 124W is the upstream section and the second section 124S is the downstream section.

In an example, shielding member 130 is a perforated metallic sheet configured to reduce an amount of coupling of microwave radiation between the first and second sections 124W and 124S while also allowing for skinned ceramic wares 10 to pass from the upstream section 124W to the downstream section 124S. As illustrated in FIG. 3, in an example, shielding member 130 is attached to ceiling 116 and downwardly depends therefrom (i.e., extends in the −z direction) towards conveyor 140 far enough to provide the reduced microwave radiation coupling while also allowing for the skinned ceramic wares 10 to be conveyed beneath the shielding member.

The first section 124W is referred to hereinafter as the “wet applicator section” because it receives wet skinned ceramic wares 10W at the input end 112 of applicator 110. The second section 124S is referred to hereinafter as the “semi-dry applicator section” because it receives semi-dry skinned ceramic wares 10S from the upstream wet applicator section 124W, as explained below.

FIG. 4 is a top-down view of system 100 but without ceiling 116 of applicator 110 so that that the wet and semi-dry skinned ceramic wares 10W and 10S can be seen within their respective wet and semi-dry applicator sections 124W and 124S.

With reference to both FIG. 3 and FIG. 4, system 100 includes a conveyor 140 that runs in the x-direction through the wet and semi-dry sections 124W and 124S of applicator 110. The conveyor 140 extends into the input end 112 of the applicator 110 and extends out of the output end 114 of the applicator. The conveyor 140 has an input location 142 just upstream of input end 112 where wet skinned ceramic wares 10W can be arranged for transport through applicator 110. In an example, wet skinned ceramic wares 10W are arranged on conveyor 140 at the input location 142 with their central axes A1 oriented in the vertical direction, shown as the z-direction.

The conveyor 140 also has an output or removal location 144 just downstream of output end 114 where dried skinned ceramic wares 10D can be outputted or removed from system 100. In an example, conveyor 140 has a conveyor speed in the range from 0.5 feet/minute to 2 feet/minute. In an example, the movement of conveyor 140 is continuous so that the skinned ceramic wares 10 are continually moved through the wet applicator section and then the semi-dry applicator section 124S during the drying process. In an example, the conveyor 140 moves at a substantially constant conveyor speed. In another example, conveyor 140 moves and stops as needed during the drying process, for example, to accommodate a shield door to open and dose at shielding member 130.

System 100 includes a microwave system 200 operably arranged relative to applicator 110. Microwave system 200 includes a microwave source system 206, which in an example includes a microwave source 210, such as a magnetron, that emits microwave radiation 212 (also referred to below as simply “microwaves”), and an antireflection device 214, such as a stub tuner, operably arranged downstream of the microwave source to prevent reflected microwaves from reaching the microwave source. A source circulator (not shown) can be disposed between the microwave source 210 and the antireflection device 214 to direct reflected power back from the applicator(s) to a water load to minimize reflected power going back to the source magnetron 210. An example magnetron 210 has a frequency f of 915 MHz and provides 100 kW of microwave power P1.

In an example, the microwave frequency f can be in the range from 20 MHz to 20000 MHz. Microwaves 212 have a wavelength λ that is related to the microwave frequency f by the relationship λ=c/f, where c is the speed of light and is about 3×10⁸ m/s. A frequency f=1000 MHz has a wavelength of about 0.3 m.

In an example, the amount of microwave power P1 employed in the drying process is based on the number of wet skinned ceramic wares 10W present in the wet applicator section 124W at a given time, wherein each wet skinned ceramic ware represents a certain amount of susceptible material. An example microwave power P1 is in the range from 10 kW to 100 kW or is in the range from 10 kW to 90 kW.

The microwave source system 206 is operably coupled to a microwave waveguide system 220 configured to guide microwaves 212. In particular, microwave waveguide system 220 includes a number of microwave feed channels or microwave waveguides (hereinafter, “waveguides”), and in particular includes a first waveguide 222 that leads to wet applicator section 124W and a second waveguide 242 that leads to semi-dry applicator section 124S. The first and second waveguides 222 and 242 are operably connected at a circulator 234, which is operably connected to antireflection device 214 via a waveguide 236.

The first waveguide 222 includes a first waveguide section 224 arranged within the wet applicator section 124W adjacent ceiling 116, while the second waveguide 242 includes a second waveguide section 244 arranged within the semi-dry applicator section 124S adjacent the ceiling. The first and second waveguides 222 and 242 are respectively configured to deliver microwave radiation to the wet applicator section 124W and the semi-dry applicator section 124S in the manner described below.

FIG. 5 is similar to FIG. 4 and shows system 100 without the applicator ceiling 116 or microwave system 200 so that the wet and semi-dry skinned ceramic wares 10W and 10S can be seen in an example drying configuration within their respective wet and semi-dry applicator sections 124W and 124S. With reference to FIG. 5, applicator 110 has dimension LX and LY, which in one example are LX=15 feet and LY=6 feet.

As best seen in FIG. 4, in an example embodiment, the first waveguide section 224 includes a U-shaped waveguide segment 226 that serves to define two spaced apart linear waveguide segments 228 that run perpendicular to conveyor 140 (i.e., they extend in the y-direction) to provide a good distribution of microwaves 212 within wet applicator section 124W. The waveguide segments 228 each includes spaced-apart slots 230 through which microwaves 112 traveling in the linear waveguide segments 228 exit (leak) into wet applicator section 124W.

The second waveguide section 244 is configured similar to the first waveguide section 224 and includes a U-shaped waveguide segment 246 that serves to define two spaced apart linear waveguide segments 248 that run perpendicular to conveyor 140 (i.e., they extend in the y-direction) to provide a good distribution of microwaves within semi-dry applicator section 124S. The waveguide segments 248 each includes spaced-apart slots 250 through which a portion of microwaves traveling in the linear waveguide sections exit (leak) into semi-dry applicator section 124S.

In the operation of system 100, microwave source system 206 generates microwaves 212 (black arrows) having the aforementioned frequency f and power P1. Of the aforementioned example frequencies f, the frequency f=915 MHz corresponds to a (free-space) wavelength λ of about 33 cm, while the frequency f=2450 MHz corresponds to a wavelength λ of about 12 cm. Generally speaking, to obtain the most uniform drying of skin 18, the skin thickness TH should be substantially smaller than the microwave wavelength λ, e.g., TH<λ/10. For a skin thickness TH of 4 mm, the microwave frequency f=2450 MHz with the corresponding wavelength λ of about 12 cm easily satisfies this criterion. In general, any microwave frequency f consistent with this criterion and that is generally effective for microwave drying can be used.

Microwaves 212 travel within waveguide 236 and through circulator 234 to first waveguide 222 and to first waveguide section 224. The microwaves 212 traveling within first waveguide section 224 exit from slots 230 in the linear waveguide segments 228 and enter the wet applicator section 124W.

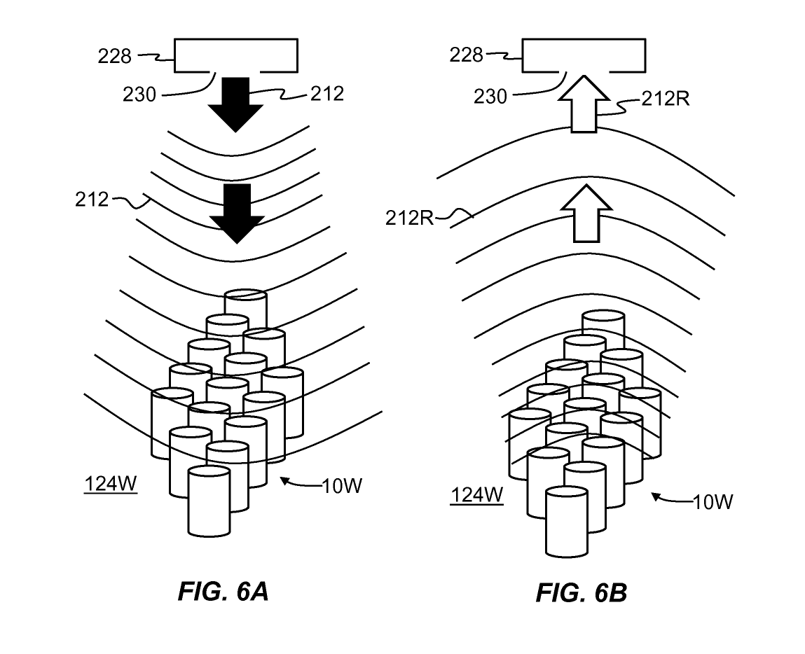

FIG. 6A is a schematic view of wet skinned ceramic wares 10W residing in wet applicator section 124W beneath one of the waveguide segments 228. The microwave radiation 212 that leaks from the waveguide segment 228 through slots 230 irradiates the wet skinned ceramic wares 10W that reside within and are being conveyed through wet applicator section 124W. A portion of this microwave radiation 212 is absorbed by wet skin 18 and initiates drying of the skin. Another portion of microwave radiation 212 is reflected by the wet skinned ceramic wares 10W, as well as by the walls 15, ceiling 16, conveyor 140 (see FIG. 3), and any other items (e.g., trays) or surfaces within the wet applicator section 124W, as reflected microwave radiation 212R, as illustrated in FIG. 6B.

The original water content in skin 18 of wet skinned ceramic wares 10W represents a relatively small percentage of the total mass of ceramic material residing in wet applicator section 124W because the other ceramic material in each wet skinned ceramic ware (i.e., the cylindrical wall 15 and cells 20) are dry. Consequently, there is a relatively high amount of reflected microwaves 212R (white arrows) from the wet skinned ceramic wares 10W as well as from the aforementioned walls 15, ceiling 16, conveyor 140, and any other items (e.g., trays) or surfaces within the wet applicator section 124W.

A portion of the reflected microwave radiation 212R enters the waveguide segments 228 through their spaced-apart slots 230. In this manner, a portion of the reflected microwave radiation 212R is captured by the waveguide segments 228 and travels back through the first waveguide 222 toward circulator 234. The captured reflected microwave radiation 212R is redirected by circulator 234 to travel within second waveguide 242 to second waveguide section 244 and to second waveguide segments 248.

In an example, the captured reflected microwave radiation 212R has a power P2 that is less than the inputted microwave power P1 and represents between 5% and 50% of the inputted microwave power P1, or in another example represents between 20% and 50% of the inputted microwave power P1.

The reflected microwave radiation 212R exits (leaks from) the second linear waveguide segments 248 through their respective slots 250 and irradiate the semi-dry skinned ceramic wares 10S that reside within and that are being conveyed through semi-dry applicator section 124S, thereby further drying the semi-dry skin 18 of the semi-dry skinned ceramic wares 10S. By the time the semi-dry skinned ceramic wares 10S exit the semi-dry applicator section 124S at the output end 114 of applicator 110, they are dried skinned ceramic wares 10D.

Thus, the first and second waveguides 222 and 242 and the circulator 234 of microwave waveguide system 220 define a reflected-microwave path 215 from wet applicator section 124W to semi-dry applicator section 124S over which reflected microwave radiation 212R can travel.

It is noted that a portion of the reflected microwaves 212R will also reflect from the semi-dry ceramic wares 10S and be captured by the second microwave segments 248 and travel in the second waveguide 242 back toward circulator 234 as doubly reflected microwave radiation 212RR (see FIG. 3). This doubly reflected microwave radiation 212RR is redirected by circulator 234 to anti-reflection device 214, which prevents this doubly reflected microwave radiation from reaching microwave source 210.

It is also pointed out that the reflected microwave radiation 212R used to irradiate semi-dry skinned ceramic wares 10S in second applicator section 124S originates in part from upstream wet skinned ceramic wares 10W in the first application section 124W. Thus, the reflected microwave radiation 212R is not used to dry the same wet skinned ceramic wares 10W from which a portion of the incident microwave radiation 212 is reflected but instead is used to dry downstream semi-dry ceramic wares in semi-dry applicator section 124S that have already passed through wet applicator section 124W.

An aspect of the method of drying wet skinned ceramic wares according to the disclosure includes maintaining the first applicator section 124W with either a sufficient number of wet skinned ceramic wares 10W to be processed or, at the end of the run, dummy ceramic wares or other material or objects or items that can be used in place of the last set of wet skinned ceramic wares to ensure a proper or desired amount of reflected microwave radiation 212R. Thus, in an example, as wet skinned ceramic wares 10W move through the first applicator section 124W by the action of conveyor 140, the other wet skinned ceramic wares 10W are added to the conveyor at the input location 142 (see FIG. 5). In an example, this backfilling process is carried out so that the wet applicator section 124W has substantially the same configuration of wet skinned ceramic wares 10W being conveyed therethrough at any given time. This in turn ensures that substantially the same amount of reflected microwaves 212R is generated and recycled to the semi-dry applicator section 124S.

The semi-dry skinned ceramic wares 10S passing through semi-dry applicator section 124S do not require as much microwave power to dry as the wet skinned ceramic wares 10W of wet applicator section 124W. Thus, system 100 is configured to recycle the reflected microwave radiation 212R from wet applicator section 124W and direct it to the semi-dry applicator section 124S for drying the semi-dry skinned ceramic wares 10S. In an example, P2<P1 and the ratio of an amount of recycled microwave power P2 provided to semi-dry applicator section 124S using reflected microwaves 212R as compared to the microwave power P1 directed to the wet applicator section 124W is in the range 0.05≦P2/P1≦0.5, or in another example is in the range 0.05≦P2/P1≦0.4.

Because system 100 makes use of a single applicator 110 divided into two immediately adjacent sections 124W and 124S rather than two spaced apart applicators, the skinned ceramic wares 10 can be processed quickly.

The use of a single microwave source system 110 reduces cost and increases drying efficiency. In an example, system 100 is capable of processing about 200 wet skinned ceramic wares 10W at a conveyor speed of about 1 foot/minute, a microwave frequency of 915 MHz and a microwave power P1 of 60 kW. In another example, system 100 is capable of processing about 333 wet skinned ceramic wares 10W at a conveyor speed of 1 foot/minute, a microwave frequency of 915 MHz and a microwave power P1 of 100 kW.

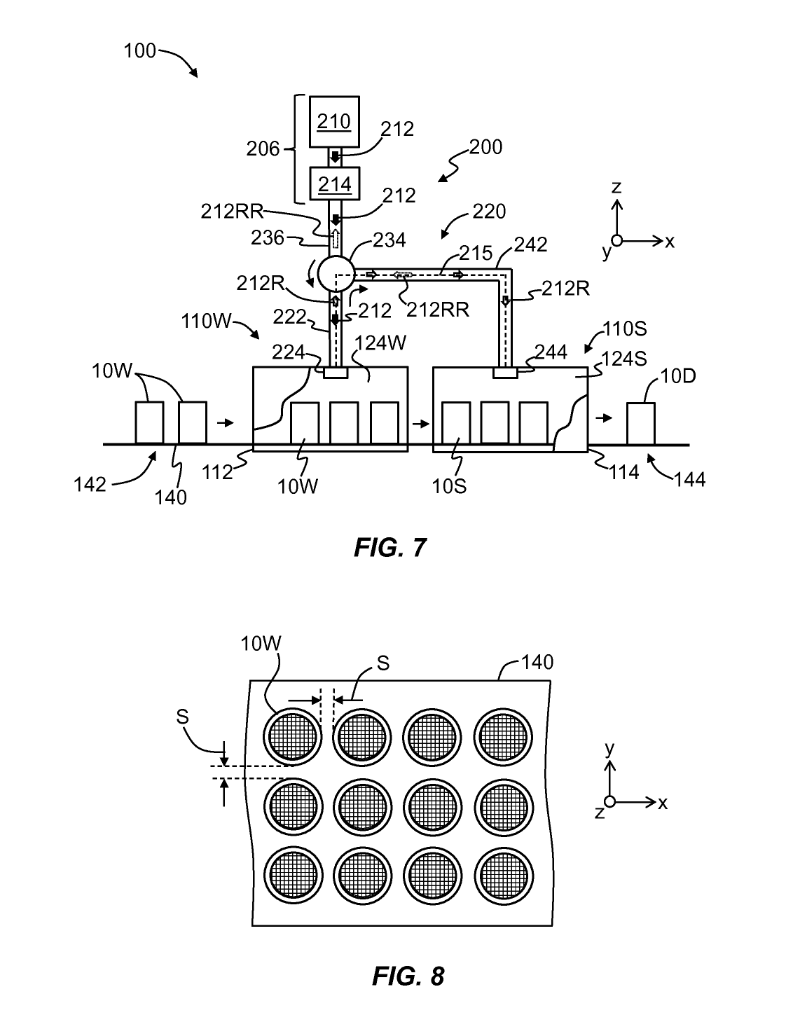

FIG. 7 is similar to FIG. 3 and illustrates an example embodiment of an alternate configuration for system 100 wherein two spaced apart applicators 110W and 110S are used to define wet applicator section 124W and 124S instead of the single applicator 110 with shielding member 130. In the example configuration of system 100 of FIG. 7, the shielding member 130 is no longer required, but the overall distance that the skinned ceramic wares 10 need to travel may be greater so that the drying time may be longer.

FIG. 8 is a top-down view of a plurality of wet skinned ceramic wares 10W on conveyor 140 illustrating an example drying configuration wherein adjacent wet skinned ceramic wares 10W (which become semi-dry skinned ceramic wares as they pass through to semi-dry applicator 124S) are spaced apart by a spacing S. In an example, the spacing S<λ/2, wherein A is the aforementioned (free-space) microwave wavelength of microwave radiation 212, as noted above. In another example, the spacing S<λ/10. The example drying configuration reduces the amount of reflected microwave radiation 212R (i.e., reduces the amount of reflected microwave power or energy) during the drying process. This provides for increased loading in the wet and semi-dry applicator sections, which makes for more efficient drying and higher throughput of system 100. In an example, the spacing S is adjusted to adjust the amount of reflected microwave radiation 212R. For example, the spacing S can be adjusted to increase the amount of reflected microwave radiation 212R rather than minimize the amount of reflected microwave radiation in order to increase the amount of microwave power P2 delivered to the semi-dry applicator section 124S.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

1. A method of drying wet skinned ceramic wares, comprising:
a) irradiating a plurality of the wet skinned ceramic wares in a first applicator section with microwave radiation having a wavelength λ and a first amount of microwave power P1, wherein said irradiating gives rise to reflected microwave radiation from the first applicator section; and
b) capturing a portion of the reflected microwave radiation and irradiating a plurality of semi-dry skinned ceramic wares in a second applicator section with the reflected microwave radiation having a second amount of microwave power P2<P1 to form dried skinned ceramic wares.

2. The method according to claim 1, wherein the first and second applicator sections reside immediately adjacent one another in a single applicator.

3. The method according to claim 1, wherein the wet skinned ceramic wares have an original skin moisture content, the semi-dry skinned ceramic wares have a skin moisture content between 30% and 60% of the original skin moisture content, and wherein the dried skinned ceramic wares have a skin moisture content of 10% or less of the original skin moisture content.

4. The method according to claim 1, wherein irradiating the plurality of the wet skinned ceramic wares in the first applicator section creates the semi-dry skinned ceramic wares, and including conveying the semi-dry skinned ceramic wares from the first applicator section to the second applicator section.

5. The method according to claim 1, wherein the ratio P2/P1 of the second and first amounts of microwave power is in the range defined by 0.05≦P2/P1≦0.4

6. The method according to claim 1, wherein the microwave radiation has a frequency in the range from 20 MHz to 20000 MHz.

7. The method according to claim 1, wherein the plurality of wet skinned ceramic wares are arranged to have a spacing S between adjacent ones of the plurality of wet skinned ceramic wares is S<λ/2.

8. The method according to claim 1, wherein the microwave radiation is provided to the first applicator section using a first microwave waveguide operably coupled to a second microwave waveguide, wherein the reflected microwave radiation is captured by the first microwave waveguide and directed to the second applicator section by the second microwave waveguide.

9. A method of performing microwave drying of multiple skinned ceramic wares formed from fired ceramic wares, the method comprising:
a) applying a layer of skin to each of the fired ceramic wares to form the multiple skinned ceramic wares;
b) irradiating the multiple skinned ceramic wares in a first applicator section with microwave radiation;
c) conveying the irradiated multiple skinned ceramic wares to a second applicator section while conveying additional multiple skinned ceramic wares into the first application section; and
d) irradiating the multiple skinned ceramic wares in the second applicator section using a portion of the microwave radiation that is reflected from the first applicator section and then directed to the second applicator section.

10. The method according to claim 9, wherein the irradiating in the first applicator section forms a semi-dry layer of skin cement on each of the skinned ceramic wares, and wherein the irradiating in the second applicator section further dries the semi-dry layer of skin cement on each of the skinned ceramic wares in the second applicator section.

11. The method according to claim 9, wherein the wet skinned ceramic wares have an original skin moisture content, the semi-dry skinned ceramic wares have a skin moisture content between 30% and 60% of the original skin moisture content, and wherein the dried skinned ceramic wares have a skin moisture content of 10% or less of the original skin moisture content.

12. The method according to claim 9, wherein the microwave radiation has a frequency in the range from 20 MHz to 20000 MHz.

13. The method according to claim 9, including continuously conveying the skinned ceramic wares from the first applicator section to the second applicator section.

14. The method according to claim 9, wherein the microwave radiation that irradiates the multiple skinned ceramic wares in a first applicator section has a power P1, wherein the portion of the microwave radiation that is reflected from the first applicator section and then directed to the second applicator section has a power P2, and wherein
0.05≦P2/P1≦0.4.

15. The method according to claim 14, wherein the power P1 is in the range from 10 kW to 90 kW.

16. A system for performing microwave drying of skinned ceramic wares, comprising:
first and second applicator sections;
a microwave source configured to generate microwave radiation; and
a microwave waveguide system comprising a first microwave waveguide operably connected to the first applicator section and to the microwave source, and a second microwave waveguide operably connected to the second applicator section and to the first microwave waveguide at a circulator arranged between the microwave source and the first applicator section to define a reflected-microwave path from the first applicator section to the second applicator section.

17. The system according to claim 16, wherein the first and second applicator sections are defined in a single applicator by a shielding member configured to reduce an amount of microwave-radiation coupling between the first and second applicator sections while also allowing for the skinned ceramic wares to travel from the first applicator section to the second applicator section.

18. The system according to claim 16, wherein the shielding member comprises a perforated metal sheet.

19. The system according to claim 16, wherein the microwave radiation has a frequency in the range from 20 MHz to 20000 MHz.

20. The system according to claim 16, further comprising a conveyor configured to convey the skinned ceramic wares through the first and second applicator sections.
